(19) United States
(12) Patent Application Publication
(10) Pub. No.: US 2012/0307111 A1
(43) Pub. Date: Dec. 6, 2012

(54) IMAGING APPARATUS, IMAGING METHOD AND IMAGE PROCESSING APPARATUS

(75) Inventor: Daisuke MIYAKOSHI, Kanagawa (JP)

(73) Assignee: Sony Corporation, Tokyo (JP)

(21) Appl. No.: 13/438,996

(22) Filed: Apr. 4, 2012

(30) Foreign Application Priority Data
Jun. 2, 2011 (JP) 2011-124055

(51) Int. Cl. H04N 5/262

(52) U.S. Cl. 348/239; 348/E05.056

(57) ABSTRACT

An imaging apparatus includes: first and second image sensors for respectively outputting first and second image data having respectively first and second pixel counts; a pixel-count conversion section for generating third image data having a third pixel count on the basis of the first image data and generating fourth image data having a pixel count equal to the third pixel count on the basis of the second image data; a similarity-degree computation section for finding a similarity degree between an image based on the first image data and an image based on the second image data on the basis of the first image data and the second image data; and a weighted-addition section for generating fifth image data by carrying out a weighted-addition operation to add image data of a similar area of the fourth image data to the third image data in accordance with the similarity degree.

### BACKGROUND

The present technique relates to an imaging apparatus, an imaging method and an image processing apparatus. More particularly, the present technique relates to an imaging apparatus having two image sensors, an imaging method provided for the imaging apparatus and an image processing apparatus employed in the imaging apparatus.

In order to raise the resolution of a taken image, there is provided a useful technique of reducing the size of every pixel of the image sensor in order to increase the number of pixels per unit area. However, the number of pixels from which signals are to be read out per unit time is limited by constraints imposed by a transmission band or other restrictions such as the chip area of the image sensor and the power consumption.

Thus, in the present state of the art, a method described below is widely adopted. That is to say, in a still-image taking operation with a relatively loose constraint such as a constraint corresponding to a frame rate of 15 fps, sufficient time is spent to read out signals from all pixels. In a monitoring operation requiring that a continuous image be read out or a moving-image taking operation with a relatively strict constraint such as a constraint corresponding to a frame rate of 60 fps, on the other hand, the number of pixels subjected to read processing is reduced and the read processing is carried out at the desired frame rate and at all face angles.

In this case, the number of pixels subjected to the read processing is reduced by carrying out a process such as a thinning-out process performed on the pixels in the vertical and horizontal directions at fixed intervals or combining a plurality of adjacent pixels having the same color on the image sensor with each other. Japanese Patent Laid-open No. 2010-252390 is a typical example of a document describing a technology of carrying out a thinning-out process on pixels subjected to read processing.

### SUMMARY

For a process to obtain a color image by making use of an image sensor, there has been devised a technique of raising the spatial resolution for every color by arranging a plurality of colors at fixed intervals alternately in an array such as the Bayer array. With this technique, however, a problem described below is raised of course for a case in which read operations are subjected to a thinning-out process carried out at certain fixed intervals and, in addition, also for a case in which a plurality of adjacent pixels having the same color on are combined with each other. In the latter case, the problem is raised in a fine pattern portion like one having a frequency exceeding a post-combination spatial sampling frequency. The problem cited above is a problem that a folding-back to the low-frequency side of high-frequency components occurs, causing a phenomenon (or jaggy) in which a false color is generated and/or inclined lines having a knurling step shape are generated. As a result, the quality of the image deteriorates.

It is thus desirable to improve the quality of an image based on data of a taken image having a high frame rate.

According to one mode of the present technique, there is provided an imaging apparatus including:

a first image sensor configured to output first image data having a first pixel count;

a second image sensor configured to output second image data having a second pixel count greater than the first pixel count;

a pixel-count conversion section configured to generate third image data having a third pixel count on the basis of the first image data output by the first image sensor and generate fourth image data having a pixel count equal to the third pixel count on the basis of the second image data output by the second image sensor;

a similarity-degree computation section configured to find the similarity degree between an image based on the first image data and an image based on the second image data on the basis of the first image data and the second image data; and

a weighted-addition section configured to generate fifth image data by carrying out a weighted-addition operation to add image data of a similar area of the fourth image data to the third image data generated by the pixel-count conversion section in accordance with the similarity degree found by the similarity-degree computation section.

As described above, the imaging apparatus according to the present technique employs first and second image sensors. The first image sensor outputs first image data having a first pixel count, whereas the second image sensor outputs second image data of pixels having a second pixel count greater than the first pixel count. In this case, the optical system of the first image sensor can be the same as the optical system of the second image sensor, or the optical system of the first image sensor can be different from the optical system of the second image sensor.

For example, the size of every pixel on the first image sensor is the same as the size of every pixel on the second image sensor and the number of pixels on the first image sensor is also the same as the number of pixels on the second image sensor. In this case, for example, a read operation is carried out on all pixels of the second image sensor at typically a low frame rate in order to obtain second image data from the second image sensor. Also in this case, for example, an all-face-angle read operation is carried out on pixels of the first image sensor at typically a high frame rate by performing a process such as a thinning-out process on pixels subjected to the read operation in the vertical and horizontal directions at fixed intervals or a process of combining a plurality of adjacent pixels having the same color on the first image sensor with each other in order to obtain first image data from the first image sensor.

In addition, as another example, the size of every pixel on the first image sensor is different from the size of every pixel on the second image sensor and the number of pixels on the first image sensor is also different from the number of pixels on the second image sensor. That is to say, for example, the size of every pixel on the first image sensor is greater than the size of every pixel on the second image sensor and the number of pixels on the first image sensor is smaller than the number of pixels on the second image sensor. In this case, for example, a read operation is carried out on all pixels of the second image sensor at typically a low frame rate in order to obtain second image data from the second image sensor. In addition, also in this case, for example, a read operation is carried out on all pixels of the first image sensor at typically a high frame rate in order to obtain first image data from the first image sensor.

The pixel-count conversion section generates third image data having a third pixel count on the basis of the first image data output by the first image sensor. In this case, if the third pixel count is greater than the first pixel count, pixel-count increasing processing to increase the number of pixels is carried out on the first image data in order to generate the third image data. The pixel-count increasing processing is also referred to as increasing scaling processing. In addition, the pixel-count conversion section also generates fourth image data of pixels, the number of which is equal to the third pixel count, on the basis of the second image data output by the second image sensor. In this case, if the third pixel count is smaller than the second pixel count, pixel-count decreasing processing to decrease the number of pixels is carried out on the second image data in order to generate the fourth image data. The pixel-count decreasing processing is also referred to as decreasing scaling processing.

The similarity-degree computation section finds the similarity degree between an image based on the first image data and an image based on the second image data on the basis of the first image data and the second image data. In this case, for example, a thinning-out processing section generates sixth image data having the first pixel count on the basis of the second image data. Then, on the basis of the first image data and the sixth image data, for each frame of the first image data, the similarity-degree computation section may find the similarity degree between every predetermined area on an image based on the first image data and a similar area on an image based on the second image data.

At that time, for example, a motion vector of the whole image is found on the basis of the first image data and the sixth image data. Then, for image data of every predetermined area of the first image data, image data of a similar area of the sixth image data is found on the basis of this motion vector. Subsequently, on the basis of the image data of every predetermined area of the first image data and the image data of the corresponding similar area of the sixth image data, the similarity-degree computation section finds the similarity degree between every predetermined area on an image based on the first image data and the corresponding similar area on an image based on the second image data for each frame of the first image data.

The weighted-addition section generates fifth image data having the third pixel count, by carrying out a weighted addition operation to add image data of a similar area of the fourth image data to the third image data for every predetermined image area in accordance with the similarity degree found by the similarity-degree computation section. In this case, the higher the similarity degree, the higher the ratio of the image data of the similar area of the fourth image data in the case of being subjected to a weighted addition operation.

As described above, according to the present technique, for example, image data having a low frame rate is subjected to a weighted-addition operation in accordance with a similarity degree to add the image data to image data having a high frame rate in order to generate output image data having a high frame rate. In the present technique, the image data having a high frame rate, the image data having a low frame rate and the output image data having a high frame rate are referred to as the third image data, the fourth image data and the fifth image data, respectively. Thus, the quality of an image based on data of a taken image having a high frame rate can be improved. If the image data having a high frame rate is image data including folding-backs caused by a thinning-out read operation or the like for example, it is possible to reduce quantities such as the number of false colors and the number of jaggy phenomena. In addition, if the image data having a high frame rate is image data output by an image sensor having few pixels for example, the resolution can be improved.

It is to be noted that the imaging apparatus according to the present technique operates typically in first and second operating modes. To be more specific, in the first operating mode, second image data generated by the second image sensor is output whereas, in the second operating mode, fifth image data generated by the weighted-addition section is output. In this case, in the second operating mode, it is possible to output data of a taken image having a high frame rate as data of an image having an improved quality.

According to another mode of the present technique, there is provided an imaging method including:

a pixel-count conversion step of generating third image data having a third pixel count on the basis of first image data output by a first image sensor as first image data having a first pixel count and generating fourth image data having a pixel count equal to the third pixel count on the basis of second image data output by a second image sensor as second image data having a second pixel count greater than the first pixel count;

a similarity-degree computation step of finding a similarity degree between an image based on the first image data and an image based on the second image data on the basis of the first image data and the second image data; and

a weighted-addition step of generating fifth image data by carrying out a weighted-addition operation to add image data of a similar area of the fourth image data generated at the pixel-count conversion step to the third image data generated at the pixel-count conversion step in accordance with the similarity degree found at the similarity-degree computation step.

According to a further mode of the present technique, there is provided an image processing apparatus including:

a pixel-count conversion section configured to generate third image data having a third pixel count on the basis of first image data having a first pixel count and generate fourth image data having a pixel count equal to the third pixel count on the basis of second image data having a second pixel count greater than the first pixel count;

a similarity-degree computation section configured to find a similarity degree between an image based on the first image data and an image based on the second image data on the basis of the first image data and the second image data; and

a weighted-addition section configured to generate fifth image data by carrying out a weighted-addition operation to add image data of a similar area of the fourth image data generated by the pixel-count conversion section to the third image data generated by the pixel-count conversion section in accordance with the similarity degree found by the similarity-degree computation section.

In accordance with the present technique, it is possible to improve the quality of an image based on data of a taken image having a high frame rate.

### BRIEF DESCRIPTION OF THE DRAWINGS

FIG. 1 is a block diagram showing a typical configuration of a camera system according to an embodiment of the present technique;

FIGS. 2A to 2D are a plurality of explanatory diagrams to be referred to in description of a typical operation carried out by a similarity-degree computation section of the camera system to compute a similarity degree;

FIG. 3 is a diagram showing timings to update an input image and timings to update a reference image for a case in which image data of the input image is data having a frame rate of 60 fps whereas image data of the reference image is data having a frame rate of 7.5 fps;

FIG. 4 is a diagram to be referred to in description of a typical operation carried out by the similarity-degree computation section of the camera system to compute a similarity degree;

FIG. 5 is a diagram showing outlines of processing carried out by blocks included in the camera system operating in a monitoring mode;

FIG. 6 is a diagram showing outlines of processing carried out by blocks included in the camera system operating in a still-image recording mode;

FIG. 7 is a diagram showing outlines of processing carried out by blocks included in the camera system operating in a moving-image recording mode;

FIG. 8 is a diagram roughly showing flows of processing carried out on data output by a sub-image sensor and a main image sensor which are operating in the moving-image recording mode;

FIG. 9 is a diagram showing timings to update an input image and timings to update a reference image for a case in which image data of the input image is data having a frame rate of 60 fps whereas image data of the reference image is data having a frame rate of 3.75 fps; and

FIG. 10 is a block diagram showing a typical configuration of another camera system according to the present technique.

### DETAILED DESCRIPTION OF THE PREFERRED EMBODIMENT

An embodiment of the present technique is described below. It is to be noted that the embodiment is explained in chapters arranged in the following order.
1. Embodiment
2. Modified Versions

### 1. Embodiment

### [Typical Configuration of Camera System]

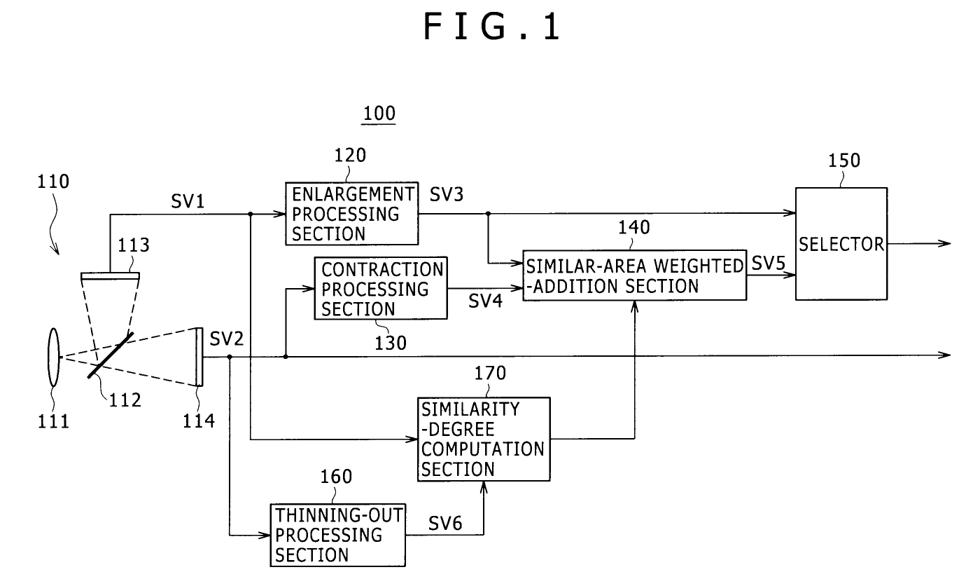

FIG. 1 is a block diagram showing a typical configuration of a camera system 100 according to an embodiment of the present technique. The camera system 100 employs an imaging section 110, an enlargement processing section 120, a contraction processing section 130, a similar-area weighted-addition section 140, a selector 150, a thinning-out processing section 160 and a similarity-degree computation section 170.

The imaging section 110 has a typical configuration including an imaging lens 111, a semi-transparent mirror 112, a sub-image sensor 113 serving as a first image sensor and a main image sensor 114 serving as a second image sensor. In this typical configuration, the sub-image sensor 113 and the main image sensor 114 share the imaging lens 111 for creating an image of an imaging object on the imaging surface of the sub-image sensor 113 and the imaging surface of the main image sensor 114. That is to say, the optical system of the sub-image sensor 113 is the same as the optical system of the main image sensor 114. In this case, the area of the light receiving surface of the sub-image sensor 113 is equal to the area of the light receiving surface of the main image sensor 114.

In the configuration described above, a part of light originated from an imaging object and captured by the imaging lens 111 is reflected by the semi-transparent mirror 112 to the sub-image sensor 113. Thus, an image of the imaging object is created on the imaging surface of the sub-image sensor 113. In addition, in the configuration, another part of light originated from the imaging object and captured by the imaging lens 111 passes through the semi-transparent mirror 112 and propagates to the main image sensor 114. Thus, an image of the imaging object is created on the imaging surface of the main image sensor 114.

The sub-image sensor 113 outputs image data SV1 having a high frame rate of typically 60 fps for few pixels. The high frame rate is referred to as a first frame rate whereas the image data SV1 having the high frame rate is referred to as first image data. The number of pixels from which the image data SV1 is output is referred to as a first pixel count. Thus, the first pixel count is the number of pixels included in the sub-image sensor 113 as pixels from which the image data SV1 is read out.

On the other hand, the main image sensor 114 outputs image data SV2 having a low frame rate of typically 7.5 fps for many pixels. The low frame rate is referred to as a second frame rate whereas the image data SV2 having the low frame rate is referred to as second image data. The number of pixels from which the image data SV2 is output is referred to as a second pixel count. Thus, the second pixel count is the number of pixels included in the main image sensor 114 as pixels from which the image data SV2 is read out.

For example, the size of every pixel on the sub-image sensor 113 is equal to the size of every pixel on the main image sensor 114 and the number of pixels on the sub-image sensor 113 is also equal to the number of pixels on the main image sensor 114. In this case, for example, a read operation is carried out on all pixels of the main image sensor 114 at a low frame rate referred to as the second frame rate in order to obtain image data SV2 referred to as the second image data from the main image sensor 114. Since the image data SV2 has not been subjected to a thinning-out process or the like, the image data SV2 is high-quality image data having few false colors and little jaggy.

Also in this case, for example, an all-face-angle read operation is carried out on pixels of the sub-image sensor 113 at a high frame rate referred to as the first frame rate by performing a process such as a thinning-out process on the pixels subjected to the read operation in the vertical and horizontal directions at fixed intervals or a process of combining a plurality of adjacent pixels having the same color on the sub-image sensor 113 with each other in order to obtain image data SV1 referred to as the first image data from the sub-image sensor 113. In comparison with the image data SV2, the image data SV1 is low-quality image data having many false colors and much jaggy.

In addition, for example, the size of every pixel on the sub-image sensor 113 is different from the size of every pixel on the main image sensor 114 and the number of pixels on the sub-image sensor 113 is also different from the number of pixels on the main image sensor 114.

That is to say, the size of every pixel on the sub-image sensor 113 is greater than the size of every pixel on the main image sensor 114 and the number of pixels on the sub-image sensor 113 is smaller than the number of pixels on the main image sensor 114.

In this case, for example, a read operation is carried out on all pixels of the main image sensor 114 at a low frame rate referred to as the second frame rate in order to obtain image data SV2 referred to as the second image data from the main image sensor 114. Since the image data SV2 has not been subjected to a thinning-out process or the like, the image data SV2 is high-quality image data having few false colors and little jaggy.

Also in this case, for example, an all-face-angle read operation is carried out on pixels of the sub-image sensor 113 at a high frame rate referred to as the first frame rate in order to obtain image data SV1 referred to as the first image data from the sub-image sensor 113. Since the sub-image sensor 113 has few pixels, the image data SV1 is low-quality image data having a low resolution.

The enlargement processing section 120 carries out increasing scaling processing on the image data SV1 output by the sub-image sensor 113 in order to generate image data SV3 of pixels, the number of which is equal to an output-pixel count referred to as a third pixel count. The image data SV3 is referred to as third image data. The increasing scaling processing is pixel-count increasing processing carried out to increase the number of pixels. That is to say, the enlargement processing section 120 changes the pixel count of the image data SV1 from the first pixel count to the third pixel count. It is to be noted that the pixel count may be left unchanged in the increasing scaling processing. If the first pixel count is left unchanged, the third pixel count can be equal to the first pixel count. The frame rate of the image data SV3 is equal to the frame rate of the image data SV1. The frame rate of the image data SV3 and the frame rate of the image data SV1 are the high frame rate referred to as the first frame rate. The enlargement processing section 120 is a portion of a pixel-count conversion section.

If the pixel count of the image data SV1 is smaller than a moving-image recording pixel count, the enlargement processing section 120 carries out the pixel-count increasing processing as necessary. An output pixel count obtained as a result of the pixel-count increasing processing is at least equal to the moving-image recording pixel count but is not greater than the pixel count of the image data SV2. That is to say, the output pixel count can be set freely at a value within a range not exceeding the number of pixels, the values of which are read out from the main image sensor 114.

The contraction processing section 130 carries out decreasing scaling processing on the image data SV2 output by the main image sensor 114 in order to generate image data SV4 of pixels, the number of which is equal to the output-pixel count referred to as the third pixel count. The image data SV4 is referred to as fourth image data. The decreasing scaling processing is pixel-count decreasing processing carried out to decrease the number of pixels. That is to say, the contraction processing section 130 decreases the pixel count of the image data SV2 to a value equal to the third pixel count obtained as a result of the pixel-count increasing processing carried out by the enlargement processing section 120. As described above, the third pixel count can be a multiple of (the same to) the first pixel count. The frame rate of the image data SV4 is equal to the frame rate of the image data SV2. The frame rate of the image data SV4 and the frame rate of the image data SV2 are the low frame rate referred to as the second frame rate. The contraction processing section 130 is also a portion of the pixel-count conversion section.

Unlike the thinning-out processing section 160, the contraction processing section 130 carries out decreasing scaling processing after proper band limitation filtering in order to generate image data having few folding-backs. It is ideal to maximize the size of the image by carrying out the increasing scaling processing on the output side of the sub-image sensor 113 without carrying out the decreasing scaling processing on the output side of the main image sensor 114. By maximizing the size of the image in this way, the effect of the image-quality improvement can be enhanced. In actuality, however, from blending of factors including the processing time, the circuit size and the power consumption, in the same way as the pixel count obtained as a result of the pixel-count increasing processing, a pixel count obtained as a result of the pixel-count decreasing processing can be set with a degree of freedom at a value within a range at least equal to the moving-image recording pixel count but not greater than the number of pixels, the values of which are read out from the main image sensor 114.

The thinning-out processing section 160 carries out thinning-out processing on the image data SV2 output by the main image sensor 114 in order to generate image data SV6 having a pixel count equal to the pixel count of the image data SV1 and having the low frame rate also referred to as the second frame rate. The image data SV6 is also referred to as sixth image data.

For each frame of the image data SV1 output by the sub-image sensor 113, the similarity-degree computation section 170 finds a similarity degree between every predetermined area on an image based on the image data SV1 and a similar area on an image based on the image data SV2 output by the main image sensor 114. That is to say, the similarity-degree computation section 170 finds a similarity degree on the basis of the image data SV1, the image data SV2, and, in the case of this embodiment, the image data SV6 output by the thinning-out processing section 160 as a result of the thinning-out processing carried out by the thinning-out processing section 160 on the image data SV2.

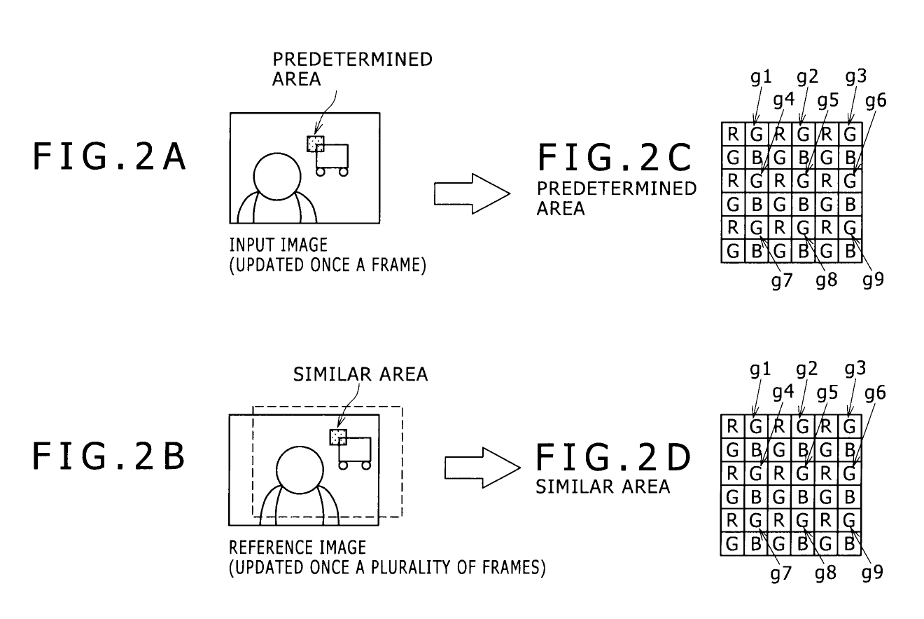

Next, the following description explains typical processing carried out by the similarity-degree computation section 170 to compute a similarity degree. FIG. 2A is a diagram showing an image based on the image data SV1 as an input image. The input image is updated for every frame of the image data SV1. On the other hand, FIG. 2B is a diagram showing an image based on the image data SV6 as a reference image. The reference image is updated for every plurality of frames of the image data SV1.

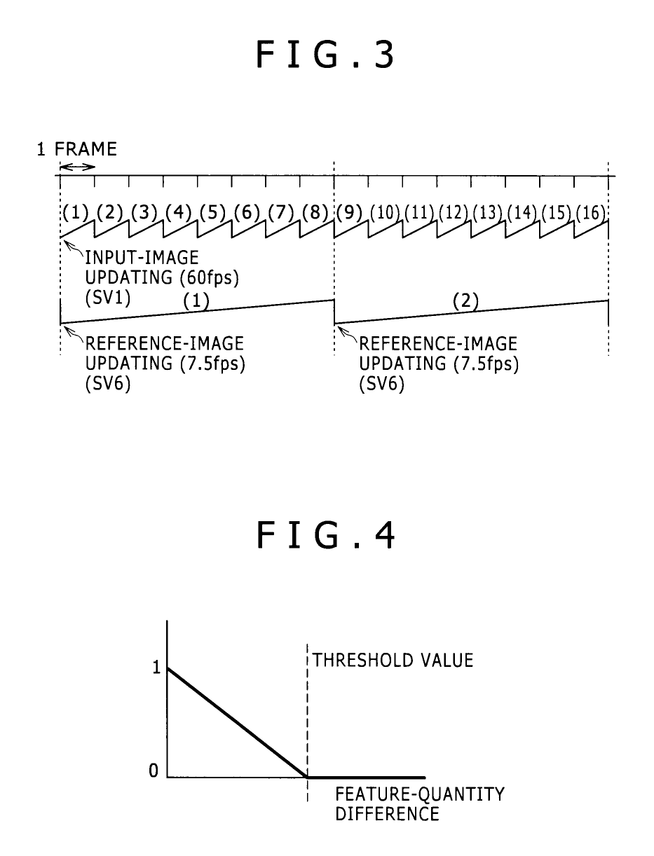

FIG. 3 is a diagram showing timings to update the input image and timings to update the reference image for a case in which the image data SV1 of the input image is data of 60 fps whereas the image data SV6 of the reference image is data of 7.5 fps. In this case, the reference image is updated once eight frames of the image data SV1.

The similarity-degree computation section 170 finds a similarity degree between every predetermined area on an input image based on the image data SV1 and a similar area on the reference image based on the image data SV2 for each frame of the image data SV1. In the case of this embodiment, in place of the similar area on the reference image based on the image data SV2, a similar area on the reference image based on the image data SV6 output as a result of the thinning-out processing carried out on the image data SV2 is used. When the similarity-degree computation section 170 finds the similarity degree for a certain frame of the image data SV1, the similarity-degree computation section 170 makes use of the frame of the image data SV1 and the corresponding frame which is a frame of the image data SV6.

In a typical case shown in FIG. 3 for example, frame (1) of the image data SV6 corresponds to frames (1) to (8) of the image data SV1 whereas frame (2) of the image data SV6 corresponds to frames (9) to (16) of the image data SV1.

First of all, the similarity-degree computation section 170 finds a motion vector of the entire reference image for the input image. Then, the similarity-degree computation section 170 finds a similarity degree between every predetermined area on the input image and a similar area on the reference image. The predetermined area on the input image is typically a rectangular area composed of pixels arranged in the horizontal x direction and the vertical y direction. The similar area on the reference image is an area corresponding to the predetermined area on the input image. The position of the similar area can be obtained from the position of the predetermined area by making use of the motion vector. It is to be noted that a dashed-line block shown in FIG. 2B is the input image shown in FIG. 2A.

The similarity-degree computation section 170 finds the similarity degree between a predetermined area shown in FIG. 2C as a certain predetermined area on the input image and a similar area shown in FIG. 2D as a similar area on the reference image by making use of data of a plurality of pixels in the predetermined area and data of a plurality of pixels in the similar area. In this case, nine pieces of green-pixel data g1 to g9 in a Bayer array are used as shown in the figures.

First of all, in both the predetermined and similar areas, the similarity-degree computation section 170 computes first, second and third feature quantities. The first feature quantity is a DC component found by computing the average of data g1 to data g9. The second feature quantity is a horizontal-direction high-frequency component (or a vertical-stripe component) found by carrying out filter computation processing represented by the following expression:

[−1×(g1+g4+g7)]+[+2×(g2+g5+g8)]+[−1×(g3+g6+g9)]

The third feature quantity is a vertical-direction high-frequency component (or a horizontal-stripe component) found by carrying out filter computation processing represented by the following expression:

[−1×(g1+g2+g3) ]+[+2×(g4+g5+g6)]+[−1×(g7+g8+g9)]

Then, the similarity-degree computation section 170 finds a difference between the first feature quantities computed for the predetermined and similar areas, a difference between the second feature quantities computed for the predetermined and similar areas and a difference between the third feature quantities computed for the predetermined and similar areas. Subsequently, the similarity-degree computation section 170 normalizes the differences typically by making use of a threshold value as shown in FIG. 4. Then, after the normalization, the similarity-degree computation section 170 subtracts 1 from the normalized values in order to find normalized feature quantities.

Subsequently, the similarity-degree computation section 170 computes the similarity degree by synthesizing the normalized first, second and third feature quantities in accordance with Eq. (1) given below. It is to be noted that, in Eq. (1), each of notations α, β and γ denotes a weight coefficient having a value in a range of 0 to 1.

Similarity degree=α×(normalized first feature quantity)+β×(normalized second feature quantity)+γ×(normalized third feature quantity) (1)

Refer back to FIG. 1. The similar-area weighted-addition section 140 carries out weighted-addition processing on the image data SV3 obtained from the enlargement processing section 120 and the image data SV4 obtained from the contraction processing section 130 in order to generate image data SV5 having the output pixel count referred to as the third pixel count. In this case, the similar-area weighted-addition section 140 carries out the weighted-addition processing on image data of each predetermined area of an image based on the image data SV3 and image data of a similar area of an image based on the image data SV4 in accordance with the similarity degree found by the similarity-degree computation section 170. In this weighted-addition processing, the higher the similarity degree, the larger the weight assigned to the image data of the similar area.

In this case, the predetermined area of an image based on the image data SV3 and the similar area on an image based on the image data SV4 correspond to respectively the predetermined area processed in the similarity-degree computation section 170 and the similar area associated with the predetermined area processed in the similarity-degree computation section 170. The predetermined area processed in the similarity-degree computation section 170 is a predetermined area of an image based on the image data SV1. However, each area processed in the similar-area weighted-addition section 140 is an area enlarged from an area processed in the similarity-degree computation section 170 in accordance with an enlargement rate used in the enlargement processing section 120 to increase the number of pixels.

The selector 150 selectively outputs the image data SV3 received from the enlargement processing section 120 or the image data SV5 received from the similar-area weighted-addition section 140.

### [Operations of the Camera System]

Next, operations carried out by the camera system 100 shown in FIG. 1 are explained as follows. The camera system 100 is capable of operating in any one of three operating modes, that is, a monitoring mode, a still-image recording mode and a moving-image recording mode. The user is allowed to select any one of the three operating modes. The three operating modes are described as follows.

First of all, the monitoring mode is explained as follows. In this monitoring mode, the power consumption of the camera system 100 is reduced at the expense of the deteriorating quality of the image. In order to reduce the power consumption, the operation of the main image sensor 114 is halted and image data generated by the sub-image sensor 113 at a high frame rate is output as a monitor image data output.

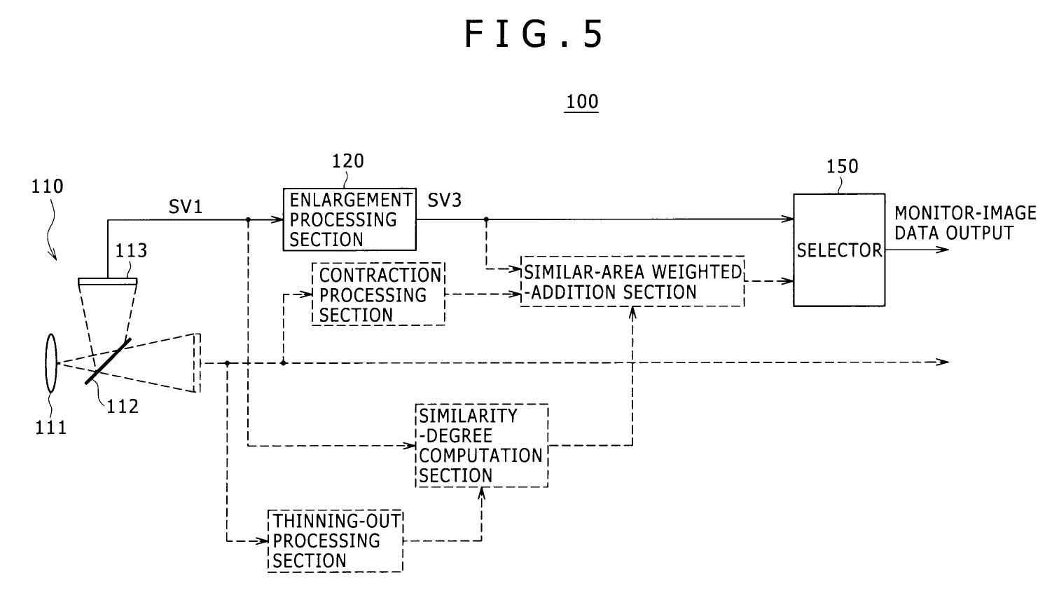

FIG. 5 is a diagram showing outlines of processing carried out by blocks included in the camera system 100 operating in the monitoring mode. In this monitoring mode, only solid-line blocks are operating and operations of dashed-line blocks are stopped. The sub-image sensor 113 outputs image data SV1 having a high frame rate referred to as the first frame rate. The image data SV1 is supplied to the enlargement processing section 120. If necessary, the enlargement processing section 120 carries out enlargement processing of increasing the pixel count for the image data SV1 in order to generate image data SV3 having the output pixel count. Then, the selector 150 outputs the image data SV3 as a monitor image data output.

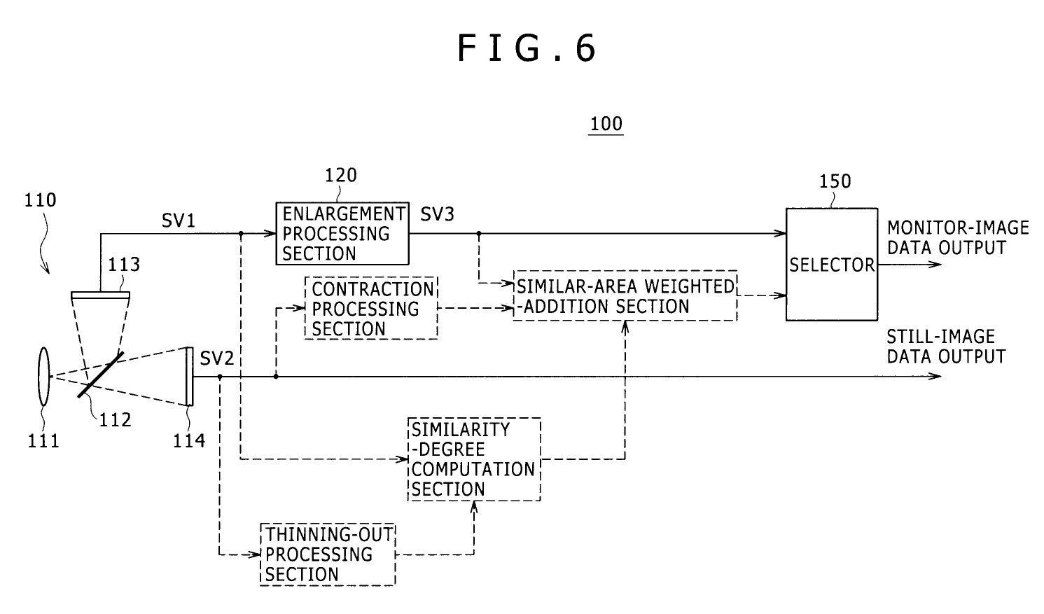

Next, the still-image recording mode is explained as follows. In the still-image recording mode, the quality of the image takes precedence over the frame rate. FIG. 6 is a diagram showing outlines of processing carried out by blocks included in the camera system 100 operating in the still-image recording mode. In the still-image recording mode, the main image sensor 114 also operates along with the solid-line blocks operating in the monitoring mode as shown in FIG. 5.

The sub-image sensor 113 outputs image data SV1 having a high frame rate referred to as the first frame rate. The image data SV1 is supplied to the enlargement processing section 120. If necessary, the enlargement processing section 120 carries out enlargement processing of increasing the pixel count for the image data SV1 in order to generate image data SV3 having the output pixel count. Then, the selector 150 outputs the image data SV3 as a monitor image data output. In addition, the main image sensor 114 outputs image data SV2 having a low frame rate. This image data SV2 is output as a still-image data output.

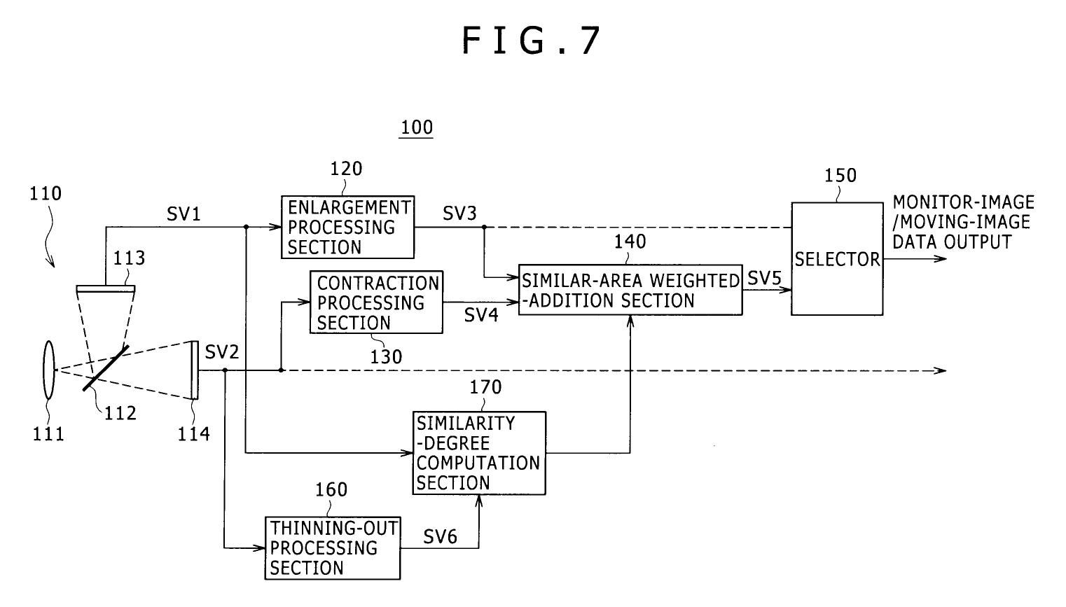

Next, the moving-image recording mode is explained as follows. In the moving-image recording mode, both the quality of the image and the frame rate are important. FIG. 7 is a diagram showing outlines of processing carried out by blocks included in the camera system 100 operating in the moving-image recording mode. In the moving-image recording mode, all the blocks operate.

The sub-image sensor 113 outputs image data SV1 having a high frame rate referred to as the first frame rate. The image data SV1 is supplied to the enlargement processing section 120. If necessary, the enlargement processing section 120 carries out enlargement processing of increasing the pixel count for the image data SV1 in order to generate image data SV3 having the output pixel count. The image data SV3 is supplied to the similar-area weighted-addition section 140.

In addition, the main image sensor 114 outputs image data SV2 having a low frame rate. This image data SV2 is supplied to the contraction processing section 130. The contraction processing section 130 carries out contraction processing of decreasing the pixel count for the image data SV2 in order to generate image data SV4 having the output pixel count. In this case, the contraction processing section 130 carries out the contraction processing after proper band limitation filtering in order to generate the image data SV4 having few folding-backs. This image data SV4 is supplied to the similar-area weighted-addition section 140.

In addition, the image data SV1 output by the sub-image sensor 113 is also supplied to the similarity-degree computation section 170. On top of that, the image data SV2 output by the main image sensor 114 is also supplied to the thinning-out processing section 160. The thinning-out processing section 160 carries out a thinning-out process on the image data SV2 in order to generate image data SV6 having a pixel count equal to the pixel count of the image data SV1 and having a low frame rate referred to as the second frame rate. This image data SV6 is supplied to the similarity-degree computation section 170.

On the basis of the image data SV1 and the image data SV6, for each frame of the image data SV1, the similarity-degree computation section 170 finds a similarity degree between every predetermined area on an input image based on the image data SV1 and a similar area on a reference image based on the image data SV2. Information on the similarity degree for every predetermined area and information on the position of the similar area corresponding to the predetermined area are supplied to the similar-area weighted-addition section 140.

The similar-area weighted-addition section 140 carries out weighted-addition processing on image data of each predetermined area on an image based on the image data SV3 and image data of a similar area on an image based on the image data SV4 in accordance with the similarity degree in order to generate image data SV5 having the output pixel count. The similar area on an image based on the image data SV4 is an area corresponding to the predetermined area on an image based on the image data SV3. It is to be noted that the similar-area weighted-addition section 140 finds out the similar area on an image based on the image data SV4 on the basis of the information on the position of the similar area. As described above, the similar-area weighted-addition section 140 receives the information on the position of the similar area from the similarity-degree computation section 170 along with the information on the similarity degree for a predetermined area corresponding to the similar area. The image data SV5 is output as monitor-image/moving-image data output from the selector 150.

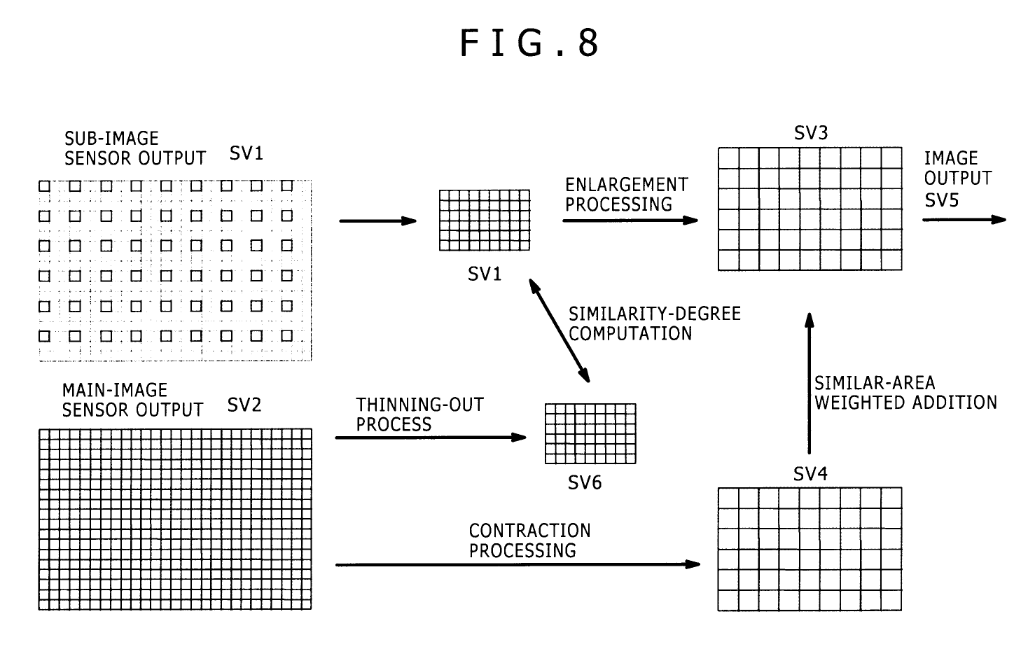

FIG. 8 is a diagram roughly showing flows of processing carried out on the image data SV1 output by the sub-image sensor 113 and the image data SV2 output by the main image sensor 114 in the moving-image recording mode in order to generate the image data SV5.

As explained before, when the camera system 100 shown in FIG. 1 is operating in the moving-image recording mode, the image data SV5 generated by the similar-area weighted-addition section 140 is output through the selector 150 as a moving-image output as shown in FIG. 7. As described above, the image data SV5 is image data obtained as a result of weighted-addition processing. The weighted addition processing is carried out to add image data of a similar area of the image data (fourth image data) SV4 having a low frame rate to every corresponding predetermined area of the image data (third image data) SV3 having a high frame rate in accordance with the similarity degree.

As described above, the taken-image data having a high frame rate is output by the selector 150 as a moving-image output. It is thus possible to improve the quality of an image based on the taken-image data having a high frame rate. If the image data SV1 generated by the sub-image sensor 113 as image data having a high frame rate is image data having folding-backs obtained as a result of typically a thinning-out process for example, false colors, jaggy phenomena and the like can be reduced. In addition, if the image data SV1 generated by the sub-image sensor 113 as image data having a high frame rate is image data output by an image sensor having a small pixel count for example, the resolution can be increased.

In addition, as explained before, the camera system 100 shown in FIG. 1 is capable of operating in any one of three operating modes, that is, the monitoring mode, the still-image recording mode and the moving-image recording mode. In the monitoring mode, only the sub-image sensor 113 operates for a high frame rate and a poor quality of the image. In the still-image recording mode, the sub-image sensor 113 and the main image sensor 114 carry out their respective operations which are independent of each other. In the moving-image recording mode, the quality of the image is improved by carrying out superposition processing according to the similarity degree between the outputs of the sub-image sensor 113 and the main image sensor 114. Since any one of these operating modes can be selected with a high degree of freedom, it is possible to carry out an operation according to a desired quality of the image, a desired frame rate and a desired power consumption. In the monitoring mode and the still-image recording mode for example, as indicated by the dashed-line blocks shown in FIGS. 5 and 6 respectively, the operations of an unnecessary image sensor and circuit portions associated with the unnecessary image sensor are stopped. Thus, the power consumption can be reduced.

In addition, in the camera system 100 shown in FIG. 1, for each frame of the image data SV1, the similarity-degree computation section 170 finds a similarity degree between every predetermined area on an image based on the image data SV1 and a similar area on an image based on the image data SV2. In this case, the similarity-degree computation section 170 finds the similarity degree on the basis of the image data SV1 output by the sub-image sensor 113 and the image data SV6 generated by the thinning-out processing section 160. The image data SV6 is image data obtained as a result of a thinning-out process on the image data SV2 as image data having a pixel count equal to that of the image data SV1. Thus, in comparison with a configuration in which the image data SV2 is directly used in the processing to find the similarity degree, the similarity degree can be found with ease because the size of the predetermined area is equal to the size of the similar area corresponding to the predetermined area (refer to FIGS. 2 and 4).

### 2. Modified Versions

It is to be noted that, in the embodiment described above, the frame rate of the image data SV2 output by the main image sensor 114 is typically 7.5 fps. However, the frame rate for the main image sensor 114 can be changed with a high degree of freedom. With the frame rate changed, in the case of a short illumination time and/or an imaging object having few movements, the frame rate for the main image sensor 114 (and the shutter speed) can be further reduced in order to improve the quality of the image by making use of a reference image including fewer noises as a base.

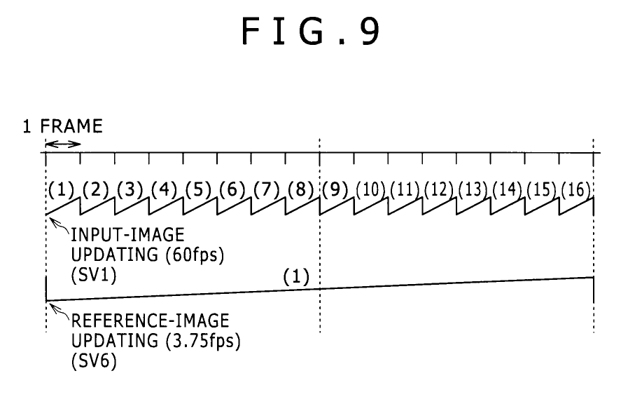

FIG. 9 is a diagram corresponding to FIG. 3. To put it in detail, FIG. 9 is a diagram showing timings to update an input image and timings to update a reference image for a case in which image data SV1 is data having a frame rate of 60 fps whereas image data SV6 is data having a frame rate of 3.75 fps. In this case, the reference image is updated once 16 frames. Also in this case, frame (1) of the image data SV6 corresponds to frames (1) to (16) of the image data SV1.

In addition, in the embodiment described above, the sub-image sensor 113 and the main image sensor 114 share the imaging lens 111 for creating an image of an imaging object on the imaging surface of the sub-image sensor 113 and the imaging surface of the main image sensor 114. That is to say, the optical system of the sub-image sensor 113 is the same as the optical system of the main image sensor 114. However, the present technique can also be applied to another camera system in which an imaging lens is provided specially for the sub-image sensor 113 to serve as a lens for creating an image of an imaging object on the imaging surface of the sub-image sensor 113 independently of another imaging lens provided specially for the main image sensor 114 to serve as a lens for creating an image of an imaging object on the imaging surface of the main image sensor 114. That is to say, in such another camera system, the optical system of the sub-image sensor 113 is different from the optical system of the main image sensor 114.

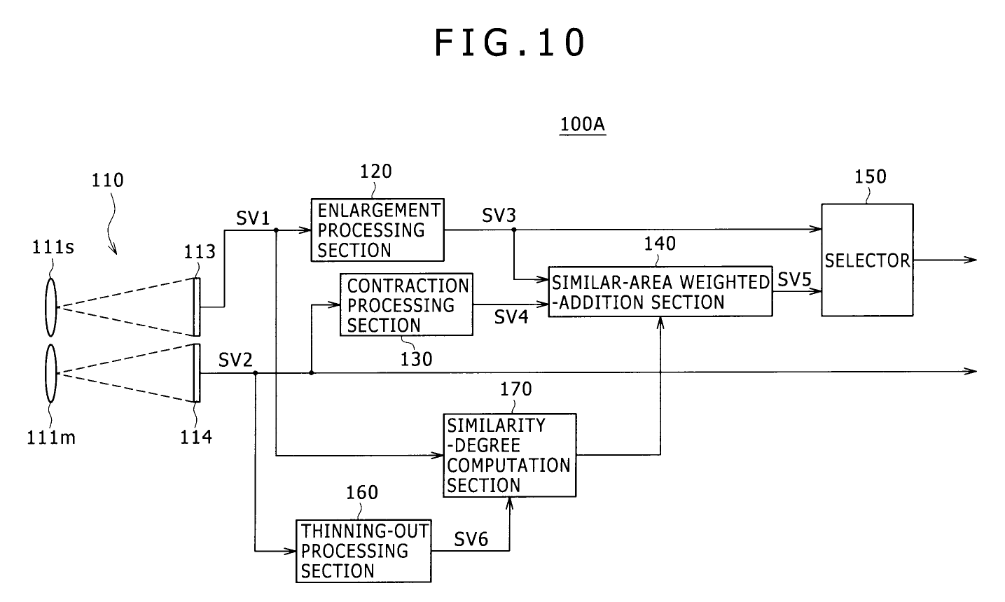

FIG. 10 is a block diagram showing a typical configuration of the other camera system 100A described above. In FIG. 10, sections identical with their respective counterparts shown in FIG. 1 are denoted by the same notations as the counterparts and detailed explanation of the identical sections is omitted from the following description. As shown in FIG. 10, the camera system 100A includes a sub-image sensor 113, a main image sensor 114, an imaging lens 111s provided for the sub-image sensor 113 and an imaging lens 111m provided for the main image sensor 114. Light originated from an imaging object and captured by the imaging lens 111s is supplied to the sub-image sensor 113 and an image of the imaging object is created on the imaging surface of the sub-image sensor 113. By the same token, light originated from the imaging object and captured by the imaging lens 111m is supplied to the main image sensor 114 and an image of the imaging object is created on the imaging surface of the main image sensor 114. Each of the other sections employed in the camera system 100A is configured in the same way as the camera system 100 shown in FIG. 1.

In addition, the present technique can also be realized into implementations described as follows:

1. An imaging apparatus including:

a first image sensor configured to output first image data having a first pixel count;

a second image sensor configured to output second image data having a second pixel count greater than the first pixel count;

a pixel-count conversion section configured to generate third image data having a third pixel count on the basis of the first image data output by the first image sensor and generate fourth image data having a pixel count equal to the third pixel count on the basis of the second image data output by the second image sensor;

a similarity-degree computation section configured to find a similarity degree between an image based on the first image data and an image based on the second image data on the basis of the first image data and the second image data; and

a weighted-addition section configured to generate fifth image data by carrying out a weighted-addition operation to add image data of a similar area of the fourth image data generated by the pixel-count conversion section to the third image data generated by the pixel-count conversion section in accordance with the similarity degree found by the similarity-degree computation section.

2. The imaging apparatus according to implementation 1, the imaging apparatus capable of operating in a first operating mode and a second operating mode, wherein:

in the first operating mode, the second image data generated by the second image sensor is output; and

in the second operating mode, the fifth image data generated by the weighted-addition section is output.

3. The imaging apparatus according to implementation 1 or 2, the imaging apparatus further having a thinning-out processing section configured to generate sixth image data having a pixel count equal to the first pixel count on the basis of the second image data output by the second image sensor, wherein, on the basis of the first image data output by the first image sensor and the sixth image data generated by the thinning-out processing section, the similarity-degree computation section finds a similarity degree of an image based on the second image data for each predetermined area of an image based on the first image data for every frame of the first image data.

4. The imaging apparatus according to implementation 3 wherein,

the similarity-degree computation section:

finds an entire-image motion vector on the basis of the first image data and the sixth image data;

finds image data of a similar area of the sixth image data as image data corresponding to image data of each predetermined area of the first image data on the basis of the motion vector; and

finds a similarity degree between each predetermined area of an image based on the first image data and a similar area of an image based on the second image data for every frame of the first image data on the basis of the image data of the predetermined area of the first image data and the corresponding image data of the similar area of the sixth image data.

5. The imaging apparatus according to any one of implementations 1 to 4, wherein the first and second image sensors share the same optical system.

6. An imaging method including:

a pixel-count conversion step of generating third image data having a third pixel count on the basis of first image data output by a first image sensor as first image data having a first pixel count and generating fourth image data having a pixel count equal to the third pixel count on the basis of second image data output by a second image sensor as second image data having a second pixel count greater than the first pixel count;

a similarity-degree computation step of finding a similarity degree between an image based on the first image data and an image based on the second image data on the basis of the first image data and the second image data; and

a weighted-addition step of generating fifth image data by carrying out a weighted-addition operation to add image data of a similar area of the fourth image data generated at the pixel-count conversion step to the third image data generated at the pixel-count conversion step in accordance with the similarity degree found at the similarity-degree computation step.

7. An image processing apparatus including:

a pixel-count conversion section configured to generate third image data having a third pixel count on the basis of first image data having a first pixel count and generate fourth image data having a pixel count equal to the third pixel count on the basis of second image data having a second pixel count greater than the first pixel count;

a similarity-degree computation section configured to find a similarity degree between an image based on the first image data and an image based on the second image data on the basis of the first image data and the second image data; and

a weighted-addition section configured to generate fifth image data by carrying out a weighted-addition operation to add image data of a similar area of the fourth image data generated by the pixel-count conversion section to the third image data generated by the pixel-count conversion section in accordance with the similarity degree found by the similarity-degree computation section.

The present technique contains subject matter related to that disclosed in Japanese Priority Patent Application JP 2011-124055 filed in the Japan Patent Office on Jun. 2, 2011, the entire content of which is hereby incorporated by reference.

While a preferred embodiment of the disclosed technique has been described using specific terms, such description is for illustrative purposes only, and it is to be understood that changes and variations may be made without departing from the spirit or scope of the following claims.

What is claimed is:

1. An imaging apparatus comprising:
a first image sensor configured to output first image data having a first pixel count;
a second image sensor configured to output second image data having a second pixel count greater than said first pixel count;
a pixel-count conversion section configured to generate third image data having a third pixel count on the basis of said first image data output by said first image sensor and generate fourth image data having a pixel count equal to said third pixel count on the basis of said second image data output by said second image sensor;
a similarity-degree computation section configured to find a similarity degree between an image based on said first image data and an image based on said second image data on the basis of said first image data and said second image data; and
a weighted-addition section configured to generate fifth image data by carrying out a weighted-addition operation to add image data of a similar area of said fourth image data generated by said pixel-count conversion section to said third image data generated by said pixel-count conversion section in accordance with said similarity degree found by said similarity-degree computation section.

2. The imaging apparatus according to claim 1, said imaging apparatus capable of operating in a first operating mode and a second operating mode, wherein:
in said first operating mode, said second image data generated by said second image sensor is output; and
in said second operating mode, said fifth image data generated by said weighted-addition section is output.

3. The imaging apparatus according to claim 1, further comprising
a thinning-out processing section configured to generate sixth image data having a pixel count equal to said first pixel count on the basis of said second image data output by said second image sensor, wherein,
on the basis of said first image data output by said first image sensor and said sixth image data generated by said thinning-out processing section, said similarity-degree computation section finds a similarity degree of an image based on said second image data for each predetermined area of an image based on said first image data for every frame of said first image data.

4. The imaging apparatus according to claim 3, wherein said similarity-degree computation section:
finds an entire-image motion vector on the basis of said first image data and said sixth image data;
finds image data of a similar area of said sixth image data as image data corresponding to image data of each predetermined area of said first image data on the basis of said motion vector; and
finds a similarity degree between each predetermined area of an image based on said first image data and a similar area of an image based on said second image data for every frame of said first image data on the basis of said image data of said predetermined area of said first image data and said corresponding image data of said similar area of said sixth image data.

5. The imaging apparatus according to claim 1, wherein said first and second image sensors share the same optical system.

6. An imaging method comprising:
a pixel-count conversion step of generating third image data having a third pixel count on the basis of first image data output by a first image sensor as first image data having a first pixel count and generating fourth image data having a pixel count equal to said third pixel count on the basis of second image data output by a second image sensor as second image data having a second pixel count greater than said first pixel count;
a similarity-degree computation step of finding a similarity degree between an image based on said first image data and an image based on said second image data on the basis of said first image data and said second image data; and
a weighted-addition step of generating fifth image data by carrying out a weighted-addition operation to add image data of a similar area of said fourth image data generated at said pixel-count conversion step to said third image data generated at said pixel-count conversion step in accordance with said similarity degree found at said similarity-degree computation step.

7. An image processing apparatus comprising:
a pixel-count conversion section configured to generate third image data having a third pixel count on the basis of first image data having a first pixel count and generate fourth image data having a pixel count equal to said third pixel count on the basis of second image data having a second pixel count greater than said first pixel count;
a similarity-degree computation section configured to find a similarity degree between an image based on said first image data and an image based on said second image data on the basis of said first image data and said second image data; and
a weighted-addition section configured to generate fifth image data by carrying out a weighted-addition operation to add image data of a similar area of said fourth image data generated by said pixel-count conversion section to said third image data generated by said pixel-count conversion section in accordance with said similarity degree found by said similarity-degree computation section.
